(19) United States
(12) Patent Application Publication
(10) Pub. No.: US 2009/0051631 A1
(43) Pub. Date: Feb. 26, 2009

(54) ELECTRO-OPTIC DEVICE AND ELECTRONIC APPARATUS

(75) Inventors: Osamu Okumura, Chino-shi (JP); Norio Koma, Motosu-Gun (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/170,507

(22) Filed: Jul. 10, 2008

(30) Foreign Application Priority Data
Aug. 20, 2007 (JP) 2007-213372

(51) Int. Cl. G09G 3/34

(52) U.S. Cl. 345/84

(57) ABSTRACT

An electro-optic device of a field sequential mode includes an electro-optic panel including a plurality of pixels and forming an image by controlling ON and OFF of the plurality of pixels; and a light source unit radiating a first color light and a second color light to the pixels of the electro-optic panel, wherein one frame time for forming one screen image in the electro-optic panel is divided into a plurality of fields including a first field and a second field, the light source unit radiating the first color light during the first field and radiating the second color light during the second field, wherein in the electro-optic panel, a first image which is related to the first color light is formed in the first field, and a second image which is related to the second color light is formed in the second field, and wherein the plurality of pixels of the electro-optic panel is not turned ON during two or more fields of one arbitrary frame time.

### BACKGROUND

1. Technical Field

The present invention relates to an electro-optic device and an electronic apparatus.

2. Related Art

As a method of performing a color display using an electro-optic panel, there have widely used a method of arranging red, green, blue micro-color filters on a plane and spatially combining them and a method of combining and radiating three red, green, blue images of the electro-optic panel using a prism. In addition, as a third method, there is a so-called field sequential mode in which red, green, and blue images are changed with high-speed to temporally mix them. Since the field sequential mode is capable of displaying colors using one pixel, the field sequential mode is suitable for a high-definition display. Moreover, since light is not absorbed by a color filter, a use efficiency of light is high (see JP-A-2002-229531).

However, the field sequential mode has a problem with “a color breakup phenomenon”. The color breakup phenomenon results from movement of human eyes. That is, in the field sequential mode, red, green, and blue images vary with time and the images are mixed due to a visual afterimage effect on the retina of human eyes, on the assumption that the same image overlaps on the same portion of the retina of the human eyes. Accordingly, when the human eyes are turned from a display and a spatial location between the human eyes and the display are thus mismatched, the same image does not overlap on the same portion of the retina of the human eyes. When the mismatch becomes larger, the human eyes recognize an image of the respective red, green, and blue colors in the outline of the images. In order to prevent the color breakup phenomenon, increasing a field frequency is effective. However, a response speed of a panel is restrictive and the color breakup phenomenon cannot be solved completely even when the field frequency is increased.

JP-A-2002-229531 discloses a driving method of reducing the color breakup phenomenon. In the driving method, there is provided a W (white) field which lightens all LED as well as R, G, and B fields. Accordingly, since a part of a brightness signal of the R, G, and B fields is input to the W field, the color breakup phenomenon reduces. However, since the driving method disclosed in JP-A-2002-229531 is devised to realize a full-color display by combination of the three primary colors, signal intensity is assigned to each of the R, G, B, and W fields. Accordingly, in principle, the driving method cannot solve the known problem with the color breakup phenomenon in that the plurality of fields are opened and a temporal additive color mixture is realized.

On the other hand, a display device of the field sequential mode has a property of high-definition and high luminance use efficiency. Accordingly, the display device of the field sequential mode is considered to be applied to various information display apparatuses such as a head-up display (HUD) of an automobile, a head mount display (HMD), a portable micro-projector, an electric bulletin board, and an instrument panel display of an AV apparatus. For example, the head-up display displays various types of information such as a vehicle speed, an amount of gasoline, and a warning by radiating an image on a front window shield (partial reflecting unit) of a vehicle. Since the head-up display is installed in a narrow dashboard, a small and high-definition panel is preferable. In addition, increasing an efficiency of light use is preferable so as not to heat the panel by the heat of an LED.

Since the above-described display device requires a bright and clear image, the color breakup phenomenon has to be completely solved. However, the color breakup phenomenon cannot be prevented in principle since the known display device performs displaying the three primary colors in a time-division manner in the same pixels. On the other hand, in the above-described display device, information to be displayed is restrictive. Accordingly, the full-color display is not necessary, and it is satisfactory that a color display (that is, multi-color display) is realized so as to display individual information of color images. Accordingly, if the known driving method for realizing the full-color display is applied, the configuration is wasteful. Moreover, a display property cannot be satisfactorily obtained.

### SUMMARY

An advantage of some aspects of the invention is that it provides an electro-optic device capable of realizing a bright and clear multi-color display using a more simplified method. Another advantage of some aspects of the invention is that it provides an electronic apparatus capable of realizing a bright and clear image display including the electro-optic device.

According to an aspect of the invention, there is provided an electro-optic device of a field sequential mode comprising: an electro-optic panel including a plurality of pixels and forming an image by controlling ON and OFF of the plurality of pixels; and a light source unit radiating a first color light and a second color light to the pixels of the electro-optic panel, wherein one frame time for forming one screen image in the electro-optic panel is divided into a plurality of fields including a first field and a second field, the light source unit radiating the first color light during the first field and radiating the second color light during the second field, wherein in the electro-optic panel, a first image which is related to the first color light is formed in the first field, and a second image which is related to the second color light is formed in the second field, and wherein the plurality of pixels of the electro-optic panel is not turned ON during two or more fields of one arbitrary frame time.

With such configuration, the pixels are turned on during maximum one field of one frame time. Accordingly, temporal additive color mixture does not occur and a problem with color breakup phenomenon does not occur in principle. In the invention, only one of the three primary colors is assigned to the pixels on the assumption of a multi-color. Accordingly, the invention cannot realize a full-color display realized by a normal field sequential mode. However, the invention can satisfactorily realize a multi-color display when the electro-optic device is applied to an information display apparatus such as an electric bulletin board and an instrument panel display of an AV apparatus in which the full-color display is not necessary.

In a known technique, since a liquid crystal response is slow at a low temperature, brightness varies depending on an ON state or an OFF state of liquid crystal of the previous field. Accordingly, color irregularity may occur. However, in the electro-optic device according to the above-described configuration, the pixels are in the OFF state during the previous field of an ON-state field. Accordingly, the colors rarely changes even though its brightness varies at a low temperature. As a result, it is possible to display a clear image.

In the known technique, reset time (black display time) of a predetermined ratio is provided to be driven within one field. The reason for inserting an black image during every one field is that a transmitted light property is realized in the form of an impulse type to obtain a good video property. In contrast, according to the invention, the pixels are basically turned off (black display) during the previous field of the ON-state field. Accordingly, even though the reset time is not provided, it is possible to obtain the good video property in the form of the impulse type.

According to the electro-optic device having the above-described configuration, the light source unit may include a plurality of color light sources that emit colors that are different from one another, and forms one color light by one of the plurality of color light sources or by combination of two or more of the color light sources. With such configuration, the color light more than the number of the color light sources can be made by combination of the color light sources. Accordingly, it is possible to increase the number of colors to be displayed while preventing the color breakup phenomenon.

According to the electro-optic device having the above-described configuration, the light source unit may form one color light by combination of light emitted by two or more of the plurality of color light sources, and adjusts a color of the color light by adjusting an intensity ratio of the light emitted by the two or more of the plurality of color light sources. With such configuration, the color light more than the number of the color light sources can be made by combination of the color light source and adjustment of the intensity ratio of the color light sources. Accordingly, it is possible to increase the number of colors to be displayed while preventing the color breakup phenomenon.

According to the electro-optic device having the above-described configuration, the light source unit may constitute a surface-shaped light source by two-dimensionally arranging a plurality of color light sources having different colors one another. With such configuration, it is possible to realize the clear display while forming multi-colors. In order to display a color image with a plurality of colors, as described above, one frame time has to be divided as many as the number of the plurality of colors in the electro-optic device according to the invention. Accordingly, the brightness of one color image reduces as many as the divided number (that is, the number of display colors) of the one frame time. However, in the configuration of the electro-optic device according to the invention, the brightness of the light source unit is large even when the display time (one field) of the color image is reduced. Accordingly, the luminance of the image does not degrade as a whole.

According to the electro-optic device having the above-described configuration, the light source unit may include a light source section, which has a plurality of color light sources that emit colors that are different from one another mounted on one chip, and a light guide plate which is arranged opposite the electro-optic panel so that the first color light and the second color light emitted by the light source section is radiated toward the electro-optic panel. With such configuration, it is possible to provide the electro-optic device having a simple and thin configuration and manufactured at low cost.

According to the electro-optic device having the above-described configuration, the electro-optic panel may be a liquid crystal panel which operates in an OCB mode or a liquid crystal panel which uses ferroelectric liquid crystal. With such configuration, it is possible to realize a satisfactory response property in the electro-optic device of the field sequential mode in which a high-speed response is required. When one frame time is divided into a plurality of fields, as described above, the response may be slow in other liquid crystal modes such as TN. However, in the liquid crystal panel using an OCB mode or ferroelectric liquid crystal, it is possible to realize a satisfactory display property when the electro-optic device according to the invention is used. Since, according to the invention, the pixels are turned off (black display) during the fields more than a half of the entire fields, it is difficult that the bent alignment returns to the splay alignment even when voltage equal to or lower than voltage for transition between bend alignment and splay alignment is applied. Therefore, in particular in the OCB mode, the bright display can be obtained.

According to the electro-optic device having the above-described configuration, the electro-optic panel includes the plurality of scanning lines electrically connected to the plurality of pixels, and the light source unit may radiate the color light after all the scanning lines of the electro-optic panel are scanned and response of all the pixels which are related to image formation becomes stable during every one field. In an electro-optic device of an active matrix mode, one screen image is formed by performing scanning from a first line to the last line. For that reason, when a light source unit radiates light in a state where the first line is completely responded, but the last line is not completely responded, luminance irregularity may occur in the upper and lower portions of a screen. However, the electro-optic device according to the invention radiates light after the scanning is performed up to the last line and the response of liquid crystal of all pixels is stabilized. With such a configuration, uniform luminance can be obtained on the entire screen, thereby realizing the bright and clear image.

According to another aspect of the invention, there is provided an electro-optic device of a field sequential mode comprising: an electro-optic panel including a plurality of pixels and a plurality of image areas which includes a first image area and a second image area; and a light source unit radiating a plurality of color light which is required to display the image, the plurality of color light including a first color light and a second color light to the pixels of the electro-optic panel, wherein an image is formed by controlling ON and OFF of the plurality of pixels, wherein one frame time for forming one screen image in the electro-optic panel is divided into a plurality of fields including a first field and a second field, the light source unit radiating the first color light during the first field and radiating the second color light during the second field, wherein in the electro-optic panel, a first image which is related to the first color light is formed in the first field, and a second image which is related to the second color light is formed in the second field, wherein the light source unit includes a plurality of color light sources that emit colors that are different from one another, and forms one of the plurality of color light by one of the plurality of color light sources or combination of two or more of the color light sources, and wherein the first image which is related to the first color light is formed in the first image area, and the second image which is related to the second color light is formed in the second image area during one arbitrary frame time.

With such configuration, the pixels are turned on during maximum one field of one frame time. Accordingly, temporal additive color mixture does not occur and the problem with color breakup phenomenon does not occur in principle. Moreover, the color light more than the number of the color light sources can be made by combination of the color light sources. Accordingly, it is possible to increase the number of colors to be displayed while preventing the color breakup phenomenon. Accordingly, the invention cannot realize a full-color display realized by a normal field sequential mode. However, the invention can satisfactorily realize a multi-color display when the electro-optic device is applied to an information display apparatus such as an electric bulletin board and an instrument panel display of an AV apparatus in which the full-color display is not necessary.

According to still another aspect of the invention, there is provided an electronic apparatus including the electro-optic device having the above-described configuration. With such configuration, it is possible to provide the electronic apparatus capable of realizing a bright and clear image display.

### BRIEF DESCRIPTION OF THE DRAWINGS

The invention will be described with reference to the accompanying drawings, wherein like numbers reference like elements.

FIG. 1 is a schematic diagram illustrating an electro-optic device according to a first embodiment.

FIG. 2 is a diagram illustrating an example of an image displayed by the electro-optic device.

FIG. 3 is a diagram for explaining a driving method of the electro-optic device.

FIG. 4 is a diagram for explaining a known driving method.

FIG. 5 is a diagram for explaining a temperature property in the known driving method.

FIG. 6 is a diagram for explaining a driving method of an electro-optic device according to a second embodiment.

FIG. 7 is a diagram for explaining a driving method of an electro-optic device according to a third embodiment.

FIG. 8 is a diagram for explaining a driving method of an electro-optic device according to a fourth embodiment.

FIG. 9 is a diagram for explaining a known driving method in a display of an orange color.

FIG. 10 is a schematic diagram illustrating an information display apparatus according to a first embodiment of an electronic apparatus.

FIG. 11 is a schematic diagram illustrating a head-up display according to a second embodiment of the electronic apparatus.

FIG. 12 shows that an image of the head-up display is viewed from a driver seat of a vehicle.

### DESCRIPTION OF EXEMPLARY EMBODIMENTS

Hereinafter, exemplary embodiments of the invention will be described with reference to the drawings. The embodiments express aspects of the invention, and the invention is not limited to the embodiments. In following embodiments, all shapes and combinations of constituent elements are just examples, and may be modified in various forms on the basis of a design request within departing the gist of the invention. In addition, the scales or numbers of the elements in a configuration are different in the following drawings to understand the element more easily.

### First Embodiment

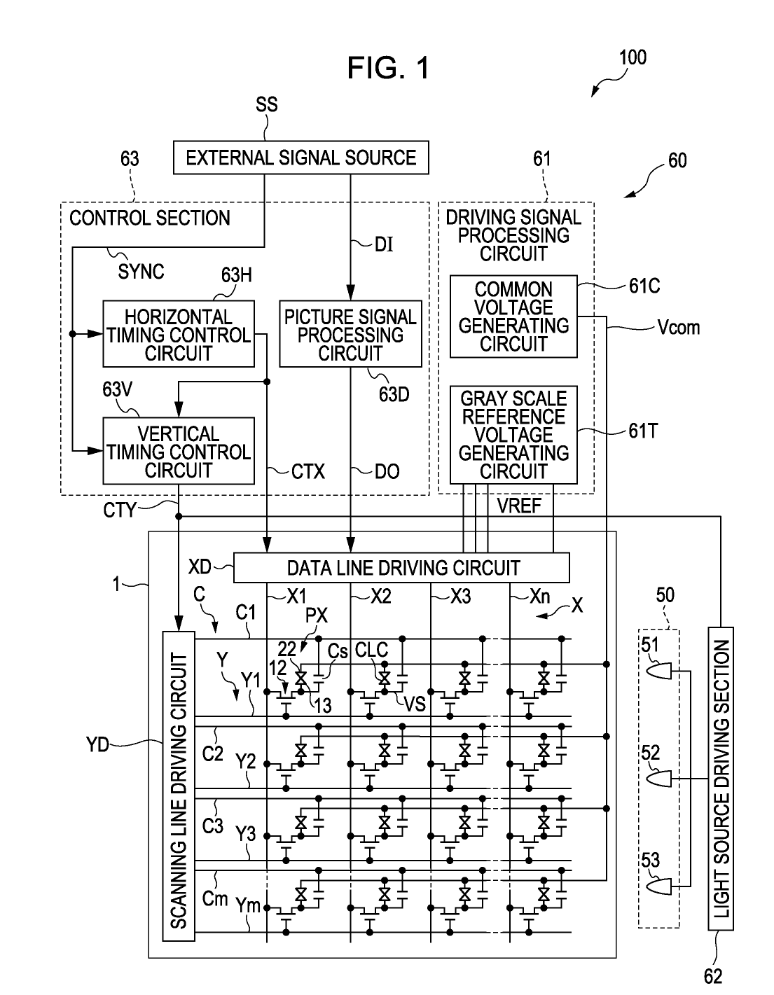

FIG. 1 is a schematic diagram illustrating a configuration of a field sequential type multi-color electro-optic device 100 according to a first embodiment of the invention. The electro-optic device 100 includes an electro-optic panel 1, a light source unit 50 for illuminating the electro-optic panel 1, and a control unit 60 for controlling the electro-optic panel 1 and the light source unit 50.

The electro-optic panel 1 is a liquid crystal panel which operates in an OCB mode or a liquid crystal panel which uses ferroelectric liquid crystal. The electro-optic panel 1 has a configuration in which a liquid crystal layer containing electro-optic substances is interposed between an array substrate and a counter substrate. The light source unit 50 is provided in the front surface (image viewing side) or the rear surface (side opposite the image viewing side) of the electro-optic panel 1. The electro-optic panel 1 can use any one of a transmissive panel and a reflective panel. When the light source unit 50 is disposed in the rear surface of the electro-optic panel 1, the electro-optic panel 1 is the transmissive liquid crystal panel and the light source unit 50 is a back-light unit. Alternatively, when the light source unit 50 is disposed in the front surface of the electro-optic panel 1, the electro-optic panel 1 is the reflective liquid crystal panel and the light source unit 50 is a front-light unit.

The electro-optic panel 1 includes plural pixels PX arranged in a matrix shape. Plural scanning lines Y (Y1 to Ym) and a plurality of storage capacitor lines C (C1 to Cm) arranged in a row direction of the pixels PX and a plurality of signal lines X (X1 to Xn) arranged in a column direction of the pixels PX are provided on the array substrate of the electro-optic panel 1. A pixel switching element 12 which controls ON and OFF of the pixels PX is provided in the vicinity of each of intersections of the scanning lines Y and the signal lines X. A pixel electrode 13 provided in every pixel PX is connected to the pixel switching element 12. The pixel electrode 13 is arranged opposite the counter electrode 22 provided on the counter substrate with the liquid crystal layer interposed therebetween. The pixel electrode 13, the liquid crystal layer, and the counter electrode 22 form a liquid crystal capacitor CLC. The liquid crystal capacitor CLC is connected in parallel to a storage capacitor Cs. The storage capacitor Cs maintains an image signal voltage with a predetermined level applied to the liquid crystal layer through the pixel electrode 13 for some time. Moreover, the storage capacitor Cs is provided between a drain of the pixel switching element 12 and each of the storage capacitor lines C.

The light source unit 50 includes color light sources 51, 52, and 53 of which colors are different from each other. In this embodiment, there are provided the red light source 51 which emits red light (R), the green light source 52 which emits green light (G), and the blue light source 53 which emits blue light (B). The read light source 51, the green light source 52, and the blue light source 53 are configured as a light-emitting diode (LED). The light source unit 50 includes a light source section (for example, a surface mount full-color chip type LED made by NICHIA Corporation, a product name: NSSM038AT) which has the plurality of color light sources 51, 52, and 53 mounted on one chip and a light guide plate which is disposed opposite the electro-optic panel 1 and radiates color light incident from the light source section toward the electro-optic panel 1. In order to improve emission brightness, a surface-shaped light emitting source in which the color light sources 51, 52, and 53 are two-dimensionally arranged in an alternating manner may be used.

The control unit 60 includes a scanning line driving circuit YD which sequentially drives the plurality of scanning lines Y1 to Ym, a data line driving circuit XD which applies a pixel voltage Vs to the plurality of data lines X1 to Xn, a driving voltage generation section 61 which generates a driving voltage of the electro-optic panel 1, a light source driving section 62 which controls the drive of the light source unit 50, and a control section 63 which controls the scanning line driving circuit YD, the data line driving circuit XD, and the light source driving section 62. The control unit 60 divides a one frame time for displaying one screen image of the electro-optic panel 1 into a plurality of fields, and drives the light source unit 50 every one field to radiate a plurality of color light in time sequence from the plurality of color light sources 51, 52, and 53. The control unit 60 controls transmissivity (ON and OFF of the pixels PX) of the electro-optic panel 1 at timing of radiating the color light from the color light sources 51, 52, and 53 during every one field to form a plurality of images in accordance with the plurality of color light on the electro-optic panel 1 in a time sequence.

The driving voltage generation section 61 includes a gray scale reference voltage generating circuit 61T which generates the predetermined number of gray scale reference voltages VREF used in the data line driving circuit XD and a common voltage generating circuit 61C which generates a common voltage Vcom to be applied to the counter electrode 22.

The control section 63 includes a vertical timing control circuit 63V which generates a control signal CTY for the scanning line driving circuit YD on the basis of a synchronization signal SYNC input from an external signal source SS, a horizontal timing control circuit 63H which generates a control signal CTX for the data line driving circuit XD on the basis of the synchronization signal SYNC input from the external signal source SS, and a picture signal processing circuit 63D which processes a picture signal DI input in a digital form from the external signal source SS to the plurality of pixels PX.

The scanning line driving circuit YD sequentially selects the plurality of scanning lines Y1 to Ym in accordance with the control signal CTY and supplies an ON voltage as a driving signal for conducting the pixel switching elements 12 of each line to the selected scanning lines Y. The data line driving circuit XD converts a picture signal DO into the pixel voltage Vs with reference to the predetermined number of gray scale reference voltage VREF supplied from the gray scale reference voltage generating circuit 61T, and outputs the converted pixel voltage Vs to the plurality of data lines X1 to Xn in parallel. The pixel voltage Vs is a voltage which is applied to the pixel electrodes 13 on the basis of the common voltage Vcom of the counter electrodes 22. For example, the polarity of the pixel voltage Vs is reversed respective to the common voltage Vcom so as to perform a frame reversion drive and a line reversion drive.

The light source driving section 62 emits the light of the plurality of color light sources 51, 52, and 53 during every one field on the basis of the control signal CTY output from the vertical timing control circuit 63V. Moreover, light source driving section 62 controls an amount of color light (emission brightness) to be radiated from the color light sources by controlling an amount of current supplied to the color light sources.

In the electro-optic device 100 having the above-described configuration, the light source unit 50 divides one frame time into three fields on the basis of the control of the light source driving section 62 to emit the light of each color light source during each field (⅓ of the one frame time). That is, the light source unit 50 sequentially emits the light of the red light source (R) 51, the light of the green light source (G) 52, and the blue light source (B) 53 every emission time to illuminate the electro-optic panel 1 with the light of the color light sources. The transmissivity of the electro-optic panel 1 is controlled in synchronization with emission of each color light source of the light source unit 50 on the basis of the control of the control unit 60, and images corresponding to each color light are sequentially displayed. In addition, a different color image (color image) of every one field is displayed at high speed. Accordingly, the plurality of color images are mixed to make a color display (field sequential mode).

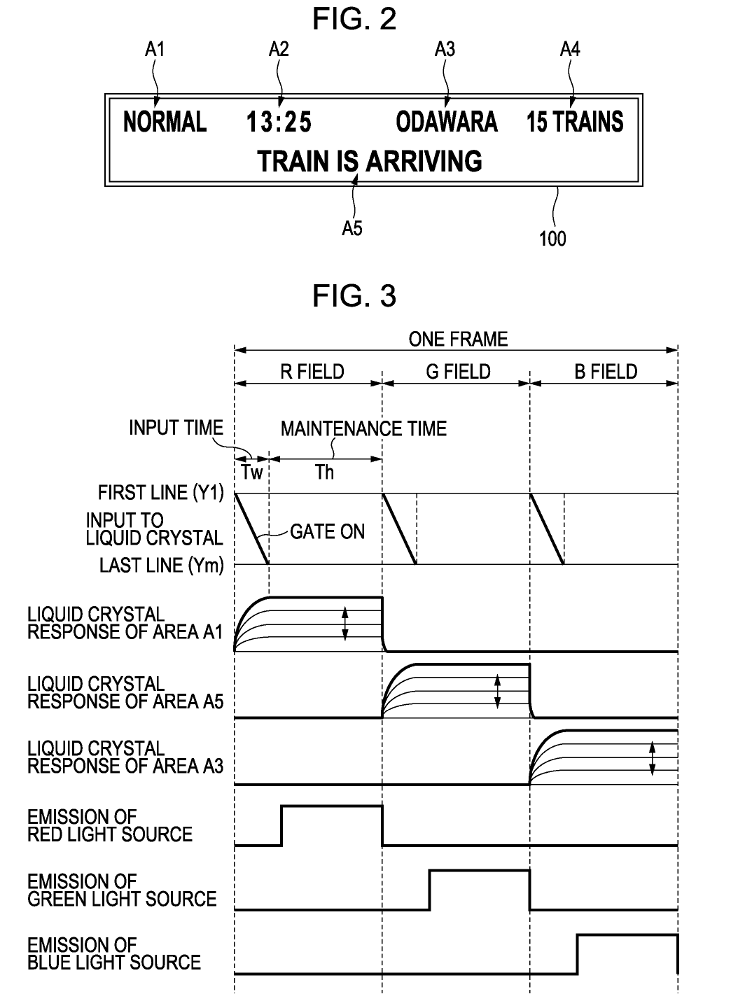

FIG. 2 is a diagram illustrating an example of an image displayed by the electro-optic device 100. According to this embodiment, the electro-optic device 100 is assumed to be a multi-color type information display apparatus such as an electric bulletin board at a station or an instrument panel display of an AV apparatus. In such an information display apparatus, a plurality of character information or image information are displayed with various colors. In the example of FIG. 2, five types of character information of “NORMAL”, “13:25”, “ODAWARA”, “15 TRAINS”, and “TRAIN IS ARRIVING” are displayed with various colors.

“NORMAL”, “13:25”, “ODAWARA”, “15 TRAINS”, and “TRAIN IS ARRIVING” are displayed in different image areas in one screen. For example, “NORMAL” is displayed on a first image area A1 located in an upper left end portion of the screen. “13:25” is displayed on a second image area A2 located in another upper left end portion of the screen. “ODAWARA” is displayed on a third image area A3 located in an upper right end portion of the screen. “15 TRAINS” is displayed on a fourth image area A4 located in another upper right end portion of the screen. “TRAIN IS ARRIVING” is displayed on a fifth image area A5 located in a lower middle portion of the screen. In another information display apparatus, at least one type of a plurality of types of information scrolls to be displayed on a screen. Even in this case, the information is arranged so as not to overlap with each other on the same screen (that is, the information is arranged in different areas on the same screen). For example, when information on train delay is displayed, the fact of the train delay or the reason for the train delay scrolls to be displayed on the area of “TRAIN IS ARRIVING”.

The image areas Al to A5 are each displayed with a color of one of the plurality of color light sources included in the light source unit. For example, in FIG. 2, “NORMAL” located in the first image area Al is displayed with a red color of the red light source, “ODAWARA” located in the third image area A3 is displayed with a blue color of the blue light source, and “TRAIN IS ARRIVING” located in the fifth image area A5 is displayed with a green color of the green light source. Different types of information can be displayed on the image areas A1 to A5 every predetermined time. Even in this case, The color of one of the plurality of color light sources included in the light source unit is assigned to the plurality of image areas of the screen, when viewed during one arbitrary frame time.

In FIG. 2, “NORMAL”, “13:25”, “ODAWARA”, “15 TRAINS”, and “TRAIN IS ARRIVING” are all character information, but image information such as an illustration may be displayed in any one thereof. For example, an illustration of a train shape can be displayed in the front or back of “TRAIN IS ARRIVING”. In this case, a part such as “TRAIN BODY”, “TRAIN WHEEL”, or “TRAIN WINDOW” of the illustration is displayed with another color. The color of one of the plurality of color light sources included in the light source unit is assigned to the part.

FIG. 3 is a diagram for explaining a method of driving the electro-optic device 100. FIG. 3 shows a timing chart of the pixels of the first image area A1 for displaying “NORMAL”, the fifth image area A5 for displaying “TRAIN IS ARRIVING”, and the third image area A3 for displaying “ODAWARA” shown in FIG. 2. In addition, a plurality of solid lines (bold line and narrow line) of “liquid crystal response” indicate gray scale of the pixels.

The control unit 60 in FIG. 1 divides one frame time (60 Hz to 70 Hz) into the plurality of fields corresponding to the number of color light radiated from the light source unit 50, and drives the electro-optic panel 1 on the basis of a color signal of each color light radiated from the light source unit 50 within each of the fields. For example, when the one frame time is 1/60 second, a red color signal is input for 1/180 second (⅓ frame time), a green color signal is input for the next 1/180 second (⅓ frame time), and a blue color signal is input for the next 1/180 second (⅓ frame time). In addition, only the red light source 51 emits light in synchronization with the input of the red color signal, only the green light source 52 emits light in synchronization with the input of the green color signal, and only the blue light source 53 emits light in synchronization with the input of the blue color signal. In this way, a red image corresponding to the red light, a green image corresponding to the green light, and a blue image corresponding to the blue light are sequentially displayed during every one field, so that they are mixed into one screen color image owing to a composite effect on human eyes.

The control unit 60 controls the drive of the electro-optic panel 1 during every one field (⅓ frame time) for radiating one color light so that writing time Tw for projecting the color light and holding time Th for maintaining the input image are set to a predetermined ratio.

During one field, the control unit 60 emits the color light only for the holding time Th for which liquid crystal alignment is stable. That is, in the electro-optic panel 1, the color light is emitted after the scanning is performed from the scanning lines Y1 to Ym and alignment of the liquid crystal of all the pixels, i.e. response of all the pixels, becomes stable. In this way, it is possible to prevent brightness irregularity from occurring in the upper and lower portions of the screen.

In this embodiment, the one screen image displayed within one frame time includes a plurality of image areas, and the image areas are displayed with a plurality of the color light radiated from the light source unit 50. Only one color light is assigned to each of the image areas, and each of the image areas is displayed with gray scale (including a black color) of the color light. In the example of FIG. 2, the five image areas of “NORMAL”, “13:25”, “ODAWARA”, “15 TRAINS”, and “TRAIN IS ARRIVING” are included in the one screen image. Any one of a red color light, a green color light, a blue color light radiated from the light source unit 50 is assigned to the character information displayed on each of the image areas.

As shown in FIG. 3, in the first image area A1, the pixels are turned on only during a red color (R) field of one frame time. Accordingly, the pixels are not turned on during a green color (G) field and a blue color (B) field. In the fifth image area A5, the pixels are turned on only during the green (G) field of the one frame time. Accordingly, the pixels are not turned on during the red color (R) field and the blue color (B) field. In the third image area A3, the pixels are turned on only during the blue (B) field of the one frame time. Accordingly, the pixels are not turned on during the red color (R) field and the green color (G) field.

Such a circumstance is the same even when the screen is changed to display another image. That is because only one color light is assigned to each of the image areas included in one screen and only one color or its gray scale is displayed on each of the image areas. Accordingly, since the pixels of the electro-optic panel 1 are turned on only during one field of one arbitrary frame time (precisely, since the black display is possible, the pixels are turned on during time shorter than one field), the pixels cannot be turned on during two fields. With such a configuration, any pixel is not turned on during two or more fields of one frame time. Accordingly, additive color mixture is not performed and a problem with color breakup phenomenon does not occur in principle. In this case, four colors of red, blue, green, and black colors and their gray scale colors (for example, dark red color) can be displayed. The full color display is not possible, but the displaying can be satisfactorily performed using the four colors in an information display apparatus such as an electric bulletin board in which a full-color display is not necessary.

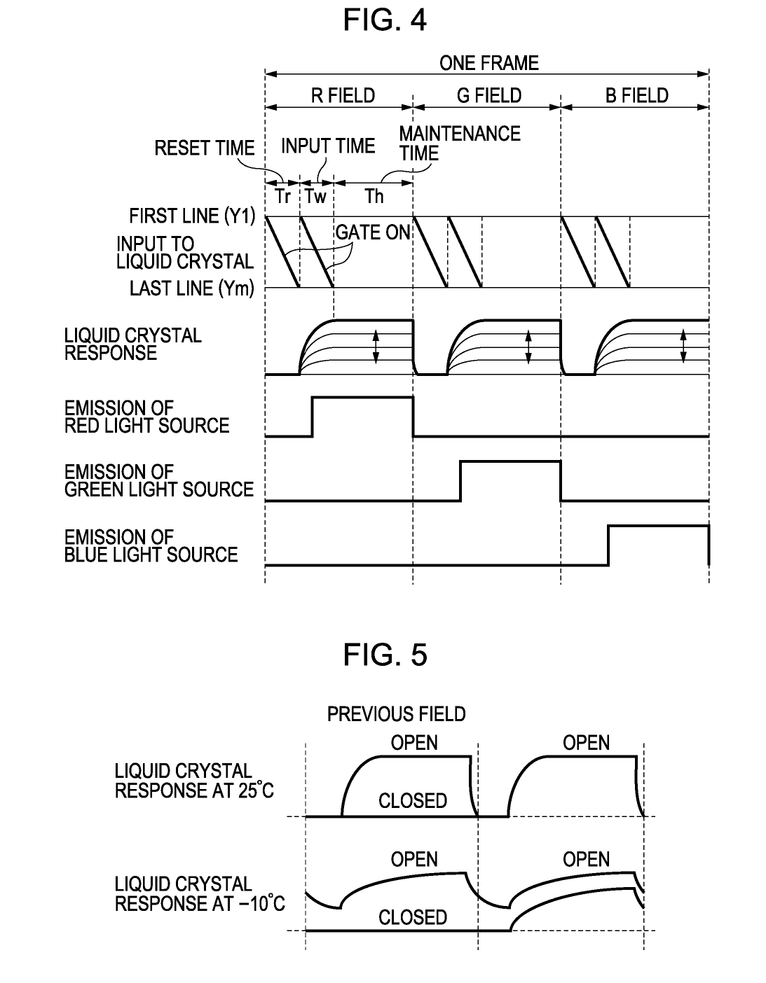

Hereinafter, advantages of the driving method according to this embodiment will be described in comparison with a known driving method. FIG. 4 is a diagram for explaining the known driving method. FIG. 5 is a diagram for explaining a temperature property in the known driving method.

As shown in FIG. 4, the known driving method displays the three primary colors in the same pixels in a time division manner on the assumption of the full-color display. Accordingly, since one pixel is turned on during two or more fields of one normal frame time, it is not possible to prevent the color breakup phenomenon from occurring in nature. In contrast, the driving method according to this embodiment assigns only one of the three primary colors to the pixels on the assumption of multi-color display. Since the pixels are turned on during maximum one field of one frame time, temporal additive color mixture does not occur and the problem with color breakup phenomenon does not occur.

As shown in FIG. 5, the known driving method has a problem in that a liquid crystal response becomes delayed at a low temperature. Brightness varies depending on an ON state or an OFF state of pixels during the previous field. In contrast, according to this embodiment, the pixels are basically turned off during a field before the field during which the pixels are turned on. Accordingly, the colors rarely changes even though its brightness varies at a low temperature. As a result, it is possible to display a clear image having excellent color reproducibility.

In the known driving method, reset time Tr (black display time) of a predetermined ratio is provided to be driven within one field. The reason for inserting an black image during every one field is that a transmitted light property is realized in the form of an impulse type to obtain a good video property. Moreover, in a case of an OCB mode, the reason is to prevent a phenomenon that bend-alignment is returned to splay alignment. In contrast, according to this embodiment, the pixels are basically turned off (black display) during the previous field of an ON-state field. Accordingly, even though the reset time is not provided, it is possible to obtain a good video property in the form of the impulse type. Moreover, in the case of the OCB mode, the bend-alignment is not returned to the spay alignment.

Specifically, voltage for obtaining the minimum transmissivity is set to 5 V, voltage for obtaining the maximum transmissivity is set to 1.2 V, and voltage for bend-splay transition is set to 2.3 V, for example. When the red color is displayed using the OCB mode in this manner, the 5V voltage is applied during the green color (G) field and the blue color (B) field. On the assumption that the voltage applied to the red color (R) field is VR, transition between the bend alignment and the splay alignment does not occur when (VR+5+5)/3 is larger than 2.3 V. Accordingly, even when the 1.2 V voltage by which the transmissivity is the maximum during the red color (R) field is applied, the transition between the bend alignment and the splay alignment does not occur, thereby realizing a clear display.

In this embodiment, the liquid crystal panel has been described using the electro-optic panel 1. However, an optical shutter (light valve) other than the liquid crystal panel or a mechanical shutter such as MEMS may be used as the electro-optic panel 1. The electro-optic device 100 which is applied to the electric bulletin board or the instrument panel display of an AV apparatus has been described. The electro-optic device 100 can be also applied to various information display apparatuses such as a head-up display (HUB) of an automobile, a head mount display (HMD), and a portable micro-projector.

### Second Embodiment

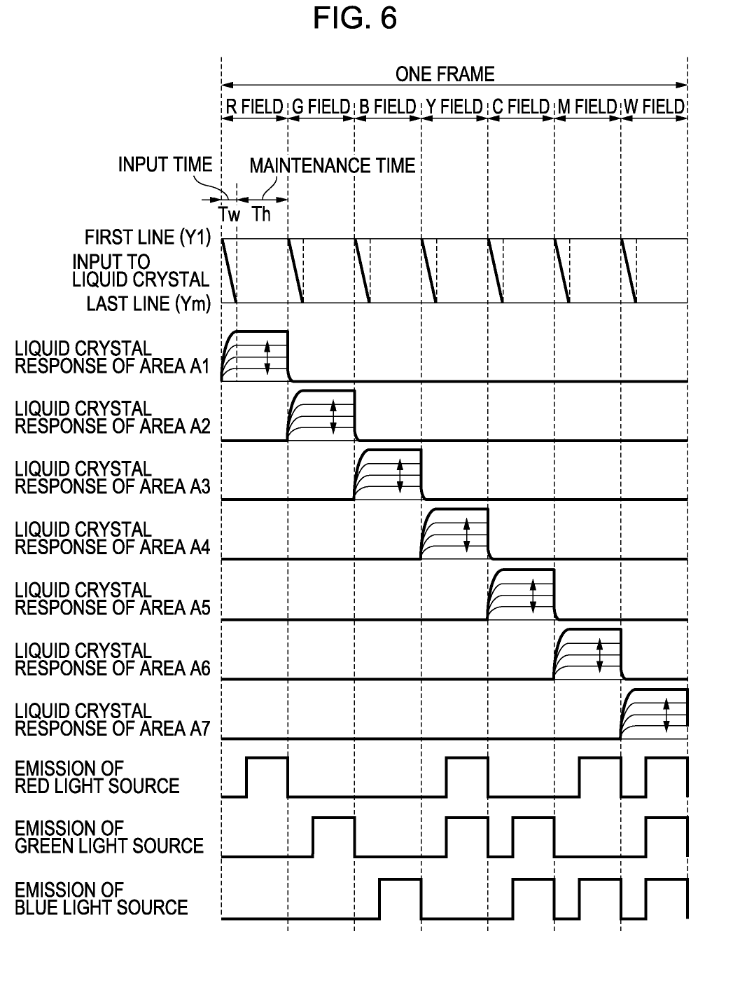

FIG. 6 is a diagram for explaining a method of driving an electro-optic device according to a second embodiment. A configuration of the electro-optic device according to this embodiment is the same as that of the electro-optic device 100 according to the first embodiment. The same reference numerals and signs are given to constituent elements which are the same as those according to the first embodiment, and the detailed explanation is omitted.

In the driving method according to this embodiment, information displayed by the electro-optic device is displayed with seven colors of red (R), green (G), blue (B), yellow (Y), cyan (C), magenta (M), and white (W). The information displayed with the red, green, blue, yellow, cyan, magenta, and white colors in one screen is displayed so as not to overlap with other image areas of the screen. A control unit 60 forms one color light by one of a plurality of color light sources or by combination of two or more of them provided with a light source unit 50, and forms the color light by the plurality of color light sources by combination of two or more of them as many as the number of the color light required to display an image. In FIG. 6, the red light source 51 and the green light source 52 are combined to form a yellow color, the green light source 52 and the blue light source 53 are combined to form a cyan color, the red light source 51 and the blue light source 53 are combined to form a magenta color, and the red light source 51, the green light source 52, and the blue light source 53 are combined to form a white color. The yellow color is formed by combining the lightening intensity of the red light source 51 and the lightening intensity of the green light source 52 to a ratio of about 1:1, the cyan color is formed by combining the lightening intensity of the green light source 52 and the lightening intensity of the blue light source 53 to a ratio of about 1:1, the magenta color is formed by combining the lightening intensity of the red light source 51 and the lightening intensity of the blue light source 53 to a ratio of about 1:1, and the white color is formed by combining the lightening intensity of the red light source 51, the lightening intensity of the green light source 52, and the lightening intensity of the blue light source 53 to a ratio of about 1:1:1.

The control unit 60 divides one frame time (60 Hz to 70 Hz) into a plurality of fields corresponding to the number of color light radiated from the light source unit 50, and drives the electro-optic panel 1 on the basis of a color signal of each color light radiated from the light source unit 50 within each of the fields. For example, when the one frame time is 1/60 second, a red color signal is input for 1/420 second ( 1/7 frame time), a green color signal is input for the next 1/420 second ( 1/7 frame time), a blue color signal is input for the next 1/420 second ( 1/7 frame time), a yellow color signal is input for the next 1/420 second ( 1/7 frame time), a cyan color signal is input for the next 1/420 second ( 1/7 frame time), a magenta color signal is input for the next 1/420 second ( 1/7 frame time), and a white color signal is input for the next 1/420 second ( 1/7 frame time). In addition, only the red light source 51 emits light in synchronization with the input of the red color signal, only the green light source 52 emits light in synchronization with the input of the green color signal, only the blue light source 53 emits light in synchronization with the input of the blue color signal, the red light source 51 and the green light source 52 emit light in synchronization with the input of the yellow color signal, the green light source 52 and the blue light source 53 emit light in synchronization with the input of the cyan color signal, the red light source 51 and the blue light source 53 emit light in synchronization with the input of the magenta color signal, the red light source 51, the green light source 52, and the blue light source 53 emit light in synchronization with the input of the white color signal. In this way, a red image corresponding to the red light, a green image corresponding to the green light, a blue image corresponding to the blue light, a yellow image corresponding to the yellow light, a cyan image corresponding to the cyan light, a magenta image corresponding to the magenta light, and a white image corresponding to the white light are sequentially displayed during every one field, so that they are mixed into one screen color image owing to a composite effect on human eyes.

The control unit 60 controls the drive of the electro-optic panel 1 during every one field ( 1/7 frame time) for radiating one color light so that input time Tw for transmitting the color light and maintenance time Th for maintaining the input image are set to a predetermined ratio.

During one field, the control unit 60 emits the color light only for the maintenance time Th for which liquid crystal alignment is stable. That is, in the electro-optic panel 1, the color light is emitted after the scanning is performed from the scanning lines Y1 to Ym and alignment of the liquid crystal of all the pixels related to image formation becomes stable. In this way, it is possible to prevent brightness irregularity from occurring in the upper and lower portions of the screen.

In this embodiment, the one screen image displayed within one frame time includes a plurality of image areas, and the image areas are displayed with a plurality of the color light radiated from the light source unit 50. Only one color light is assigned to each of the image areas, and each of the image areas is displayed with gray scale (including a black color) of the color light. In a first image area A1, the pixels are turned on only during a red color (R) field of one frame time, and the pixels are not turned on during other fields. Likewise, in a second image area A2, the pixels are turned on only during a green color (G) field of one frame time, and the pixels are not turned on during other fields. In a third image area A3, the pixels are turned on only during a blue color (B) field of one frame time, and the pixels are not turned on during other fields. In a fourth image area A4, the pixels are turned on only during a yellow color (Y) field of one frame time, and the pixels are not turned on during other fields. In a fifth image area A5, the pixels are turned on only during a cyan color (C) field of one frame time, and the pixels are not turned on during other fields. In a sixth image area A6, the pixels are turned on only during a magenta color (M) field of one frame time, and the pixels are not turned on during other fields. In a seventh image area A7, the pixels are turned on only during a white color (W) field of one frame time, and the pixels are not turned on during other fields.

Such a circumstance is the same even when the screen is changed to display another image. That is because only one color light is assigned to each of the image areas included in one screen and only one color or its gray scale is displayed on each of the image areas. Accordingly, since the pixels of the electro-optic panel 1 are turned on only during one field of one arbitrary frame time (precisely, since a black display is possible, the pixels are turned on during time shorter than one field), the pixels cannot be turned on during two fields. With such a configuration, any pixel is not turned on during two or more fields of one frame time. Accordingly, additive color mixture is not performed and a problem with color breakup phenomenon does not occur in principle. In this case, eight colors of red, blue, green, yellow, cyan, magenta, white, and black colors and their gray scale colors can be displayed. The full color display is not possible, but the displaying can be satisfactorily performed just using the eight colors in an information display apparatus such as an electric bulletin board in which a full-color display is not necessary.

The electro-optic device according to this embodiment assigns only one of the plurality of color light radiated from the light source unit 50 to the pixels. Accordingly, temporal additive color mixture does not occur and the problem with color breakup phenomenon does not occur. Moreover, since the pixels are basically turned off during the previous field of an ON-state field, the colors rarely changes even though its brightness varies at a low temperature. As a result, it is possible to display a clear image having excellent color reproducibility. According to this embodiment, one color light is formed by one of the plurality of color light sources or by combination of two or more of the plurality of color light sources. Accordingly, it is possible to make lights more than the color lights of the color light sources. As a result, it is possible to increase the number of colors while preventing a color breakup phenomenon.

### Third Embodiment

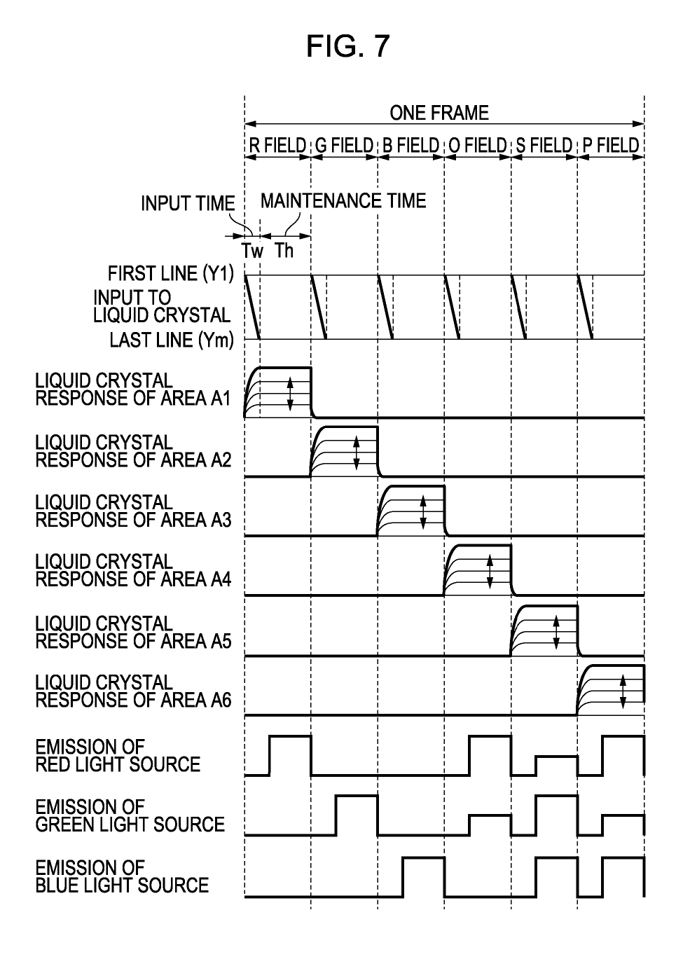

FIG. 7 is a diagram for explaining a method of driving an electro-optic device according to a third embodiment. A configuration of the electro-optic device according to this embodiment is the same as that of the electro-optic device 100 according to the first embodiment. The same reference numerals and signs are given to constituent elements which are the same as those according to the first embodiment, and the detailed explanation is omitted.

In the driving method according to this embodiment, information displayed by the electro-optic device is displayed with six colors of red (R), green (G), blue (B), orange (O), sky blue (S), and pink (P). The information displayed with the red, green, blue, orange, sky blue, and pink colors in one screen is displayed so as not to overlap with other image areas of the screen. A control unit 60 forms one color light by one of a plurality of color light sources or by combination of two or more of them (a red light source 51, a green light source 52, and a blue light source 53) provided with a light source unit 50, and forms the color light by the plurality of color light sources and by combination of two or more of them as many as the number of the color light required to display an image. In FIG. 7, the red light source 51 and the green light source 52 are combined to form an orange color, the red light source 51, the green light source 52, and the light source 53 are combined to form a sky blue color, and the red light source 51, the green light source 52, and the blue light source 53 are combined to form a pink color. The orange color is formed by combining the lightening intensity of the red light source 51 and the lightening intensity of the green light source 52 to a ratio of about 2:1, the sky blue color is formed by combining the lightening intensity of the red light source 51, the lightening intensity of the green light source 52, and the lightening intensity of the blue light source 53 to a ratio of about 1:2:2, and the pink color is formed by combining the lightening intensity of the red light source 51, the lightening intensity of the green light source 52, and the lightening intensity of the blue light source 53 to a ratio of about 2:1:2.

The control unit 60 divides one frame time (60 Hz to 70 Hz) into a plurality of fields corresponding to the number of color light radiated from the light source unit 50, and drives the electro-optic panel 1 on the basis of a color signal of each color light radiated from the light source unit 50 within each of the fields. For example, when the one frame time is 1/60 second, a red color signal is input for 1/360 second (⅙ frame time), a green color signal is input for the next 1/360 second (⅙ frame time), a blue color signal is input for the next 1/360 second (⅙ frame time), an orange color signal is input for the next 1/360 second (⅙ frame time), and a sky blue color signal is input for the next 1/360 second (⅙ frame time), and a pink color signal is input for the next 1/360 second (⅙ frame time). In addition, only the red light source 51 emits light in synchronization with the input of the red color signal, only the green light source 52 emits light in synchronization with the input of the green color signal, only the blue light source 53 emits light in synchronization with the input of the blue color signal, the red light source 51 and the green light source 52 emit light in synchronization with the input of the orange color signal, the red light source 51, the green light source 52, and the blue light source 53 emit light in synchronization with the input of the sky blue color signal, the red light source 51, the green light source 52, and the blue light source 53 emit light in synchronization with the input of the pink color signal. In this way, a red image corresponding to the red light, a green image corresponding to the green light, a blue image corresponding to the blue light, an orange image corresponding to the orange light, a sky blue image corresponding to the sky blue light, and a pink image corresponding to the pink light are sequentially displayed during every one field, so that they are mixed into one screen color image owing to a composite effect on human eyes.

The control unit 60 controls the drive of the electro-optic panel 1 during every one field (⅙ frame time) for radiating one color light so that input time Tw for transmitting the color light and maintenance time Th for maintaining the input image are set to a predetermined ratio.

During one field, the control unit 60 emits the color light only for the maintenance time Th for which liquid crystal alignment is stable. That is, in the electro-optic panel 1, the color light is emitted after the scanning is performed from the scanning lines Y1 to Ym and alignment of the liquid crystal of all the pixels related to image formation becomes stable. In this way, it is possible to prevent brightness irregularity from occurring in the upper and lower portions of the screen.

In this embodiment, the one screen image displayed within one frame time includes a plurality of image areas, and the image areas are displayed with a plurality of the color light radiated from the light source unit 50. Only one color light is assigned to each of the image areas, and each of the image areas is displayed with gray scale (including a black color) of the color light. In a first image area A1, the pixels are turned on only during a red color (R) field of one frame time, and the pixels are not turned on during other fields. Likewise, in a second image area A2, the pixels are turned on only during a green color (G) field of one frame time, and the pixels are not turned on during other fields. In a third image area A3, the pixels are turned on only during a blue color (B) field of one frame time, and the pixels are not turned on during other fields. In a fourth image area A4, the pixels are turned on only during an orange color (O) field of one frame time, and the pixels are not turned on during other fields. In a fifth image area A5, the pixels are turned on only during a sky blue color (S) field of one frame time, and the pixels are not turned on during other fields. In a sixth image area A6, the pixels are turned on only during a pink color (P) field of one frame time, and the pixels are not turned on during other fields.

Such a circumstance is the same even when the screen is changed to display another image. That is because only one color light is assigned to each of the image areas included in one screen and only one color or its gray scale is displayed on each of the image areas. Accordingly, since the pixels of the electro-optic panel 1 are turned on only during one field of one arbitrary frame time (precisely, since a black display is possible, the pixels are turned on during time shorter than one field), the pixels cannot be turned on during two fields. With such a configuration, any pixel is not turned on during two or more fields of one frame time. Accordingly, additive color mixture is not performed and a problem with color breakup phenomenon does not occur in principle. In this case, seven colors of red, blue, green, orange, sky blue, pink, and black colors and their gray scale colors can be displayed. The full color display is not possible, but the displaying can be satisfactorily performed just using the seven colors in an information display apparatus such as an electric bulletin board in which a full-color display is not necessary.

The electro-optic device according to this embodiment assigns only one of the plurality of color light radiated from the light source unit 50 to the pixels. Accordingly, temporal additive color mixture does not occur and the problem with color breakup phenomenon does not occur. Moreover, since the pixels are basically turned off during the previous field of an ON-state field, the colors rarely changes even though its brightness varies at a low temperature. As a result, it is possible to display a clear image having excellent color reproducibility.

According to this embodiment, six types of color light have been formed using three color light sources, but the color type is not limited to the above-described color types. The color light sources and the intensity ratio are arbitrarily combined, and moreover any color light can be made according to the combination of the color light source and the intensity ratio. Various types of information can be displayed by increasing the number of color light.

### Fourth Embodiment

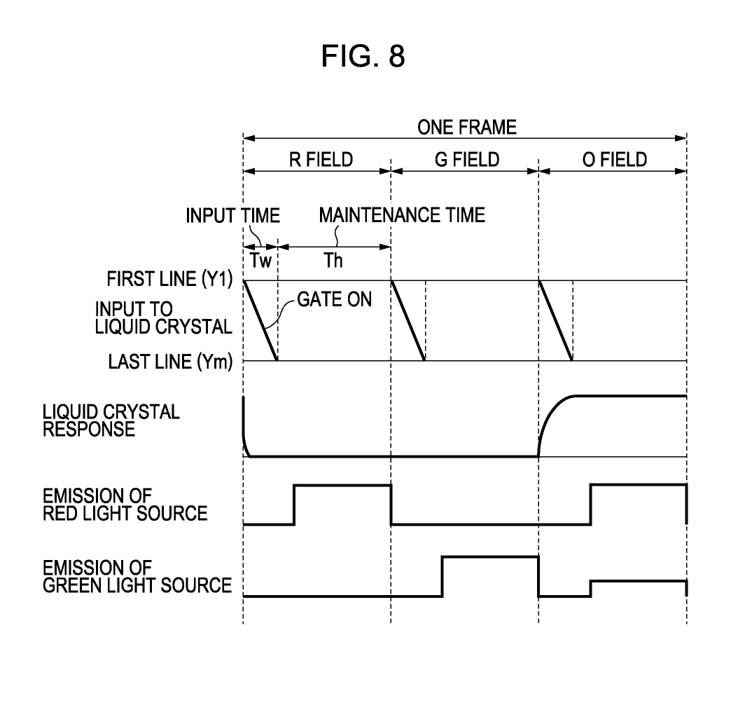

FIG. 8 is a diagram for explaining a method of driving an electro-optic device according to a fourth embodiment. A configuration of the electro-optic device according to this embodiment is the same as that of the electro-optic device 100 according to the first embodiment. The same reference numerals and signs are given to constituent elements which are the same as those according to the first embodiment, and the detailed explanation is omitted.

It is assumed that the electro-optic device according to this embodiment is a multi-color type information display apparatus such as an electric bulletin board which can be seen at a station. The electro-optic device performs a display using three colors of red, green, and orange colors. Since color light sources to be used are just a red light source and a green light source, the color light sources are combined to form the orange color. As the red light source, a surface mount chip type LED (product name: NESR064) can be used. As the green light source, a surface mount chip type LED (product name: NESG064) can be used. As the light source unit, a surface-shaped light emitting source in which the color light sources are two-dimensionally arranged in an alternating manner may be used to display an image with high brightness.

In the driving method according to this embodiment, information displayed by the electro-optic device is displayed with the three colors of the red (R), green (G), and orange (O) colors. The information displayed with the red, green, and orange colors in one screen is displayed so as not to overlap with other image areas of the screen. A control unit 60 forms one color light by one of a plurality of color light sources or by combination of two or more of them (a red light source and a green light source) provided with a light source unit, and forms the color light by the plurality of color light sources and by combination of two or more of them as many as the number of the color light required to display an image. In FIG. 8, the red light source and the green light source are combined to form the orange color. The orange color is formed by combining the lightening intensity of the red light source and the lightening intensity of the green light source to a ratio of about 2:1.

The control unit 60 divides one frame time (60 Hz to 70 Hz) into a plurality of fields corresponding to the number of color light radiated from the light source unit, and drives the electro-optic panel 1 on the basis of a color signal of each color light radiated from the light source unit within each of the fields. For example, when the one frame time is 1/60 second, a red color signal is input for 1/180 second (⅓ frame time), a green color signal is input for the next 1/180 second (⅓ frame time), and an orange color signal is input for the next 1/180 second (⅓ frame time). In addition, only the red light source emits light in synchronization with the input of the red color signal, only the green light source emits light in synchronization with the input of the green color signal, and the red light source and the green light source emit light in synchronization with the input of the orange color signal. In this way, a red image corresponding to the red light, a green image corresponding to the green light, and an orange image corresponding to the orange light are sequentially displayed during every one field, so that they are mixed into one screen color image owing to a composite effect on human eyes.

The control unit 60 controls the drive of the electro-optic panel 1 during every one field (⅓ frame time) for radiating one color light so that input time Tw for transmitting the color light and maintenance time Th for maintaining the input image are set to a predetermined ratio.

During one field, the control unit 60 emits the color light only for the maintenance time Th for which liquid crystal alignment is stable. That is, in the electro-optic panel 1, the color light is emitted after the scanning is performed from the scanning lines Y1 to Ym and alignment of the liquid crystal of all the pixels related to image formation becomes stable. In this way, it is possible to prevent brightness irregularity from occurring in the upper and lower portions of the screen.

In this embodiment, the one screen image displayed within one frame time includes a plurality of image areas, and the image areas are displayed with a plurality of the color light radiated from the light source unit. Only one color light is assigned to each of the image areas, and each of the image areas is displayed with gray scale (including a black color) of the color light. For example, in an image area displayed with the orange color, the pixels are turned on only during an orange color (O) field of one frame time, and the pixels are not turned on during other fields. Likewise, in an image area displayed with the red color, the pixels are turned on only during a red color (R) field of one frame time, and the pixels are not turned on during other fields. In an image area displayed with the green color, the pixels are turned on only during a green color (G) field of one frame time, and the pixels are not turned on during other fields.

Such a circumstance is the same even when the screen is changed to display another image. That is because only one color light is assigned to each of the image areas included in one screen and only one color or its gray scale is displayed on each of the image areas. Accordingly, since the pixels of the electro-optic panel 1 are turned on only during one field of one arbitrary frame time (precisely, since a black display is possible, the pixels are turned on during time shorter than one field), the pixels cannot be turned on during two fields. With such a configuration, any pixel is not turned on during two or more fields of one frame time. Accordingly, additive color mixture is not performed and a problem with color breakup does not occur in principle. In this case, four colors of red, blue, and orange colors and their gray scale colors can be displayed. The full color display is not possible, but the displaying can be satisfactorily performed just using the four colors in an information display apparatus such as an electric bulletin board in which a full-color display is not necessary.

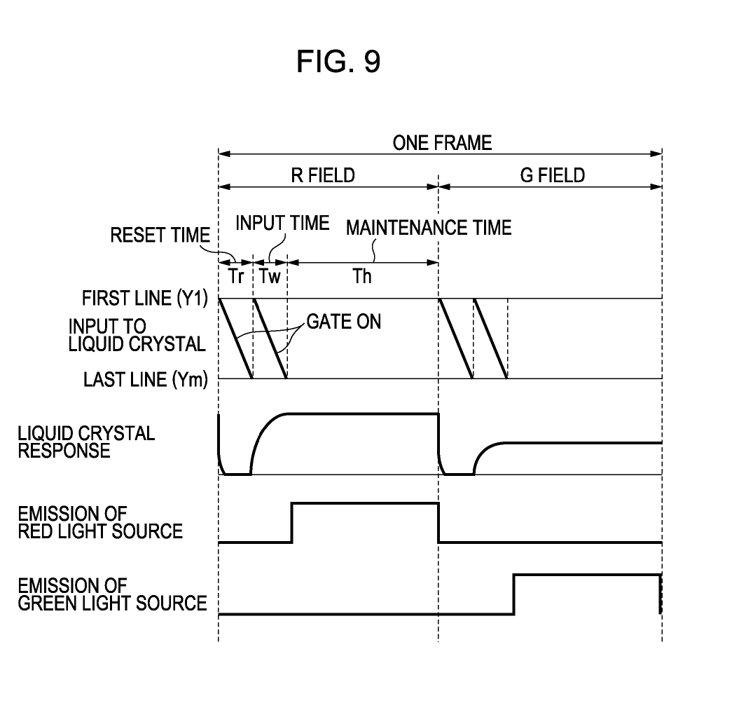

Hereinafter, advantages of the driving method according to this embodiment will be described in comparison with a known driving method. FIG. 9 is a diagram for explaining the known driving method in a display of the orange color. As shown in FIG. 8, the driving method according to this embodiment displays the orange color by lightening the red light source entirely and lightening the green light source during the orange (O) field by half. The known driving method of the comparison example displays the orange color by lightening the red light source and the green light source entirely during the red color (R) and the green color (G) field and by opening liquid crystal entirely during the red color field and opening the liquid crystal by half during the green color field, instead. Accordingly, energy loss in the known driving method is larger by an amount of light blocked by the liquid crystal. However, the known driving method has an advantage of obtaining a brighter display since lightening time of the color light sources is longer by the smaller number of pulses. Even in this case, the luminance does not degrade in spite of the energy loss when a surface-shaped light source two-dimensionally arranged with a plurality of color light sources is used as the light source unit.

The most significant difference between this embodiment and the comparison example is that in the comparison example, a color breakup phenomenon that the orange display is broken into the red color and the green color occurs in one's eyes are turned since the orange color is displayed using another field. Such a color breakup phenomenon is serious in an information display apparatus outdoors. That is because a viewer turns one's eyes to another place after viewing the information displayed on the information display apparatus. In the electro-optic device according to this embodiment, a plurality of colors are not mixed within one pixel in a time-division manner (additive color mixture). Accordingly, the color breakup phenomenon does not occur even through one's eyes are turned swiftly, and the viewer does not feel uneasiness.

### First Embodiment of Electronic Apparatus

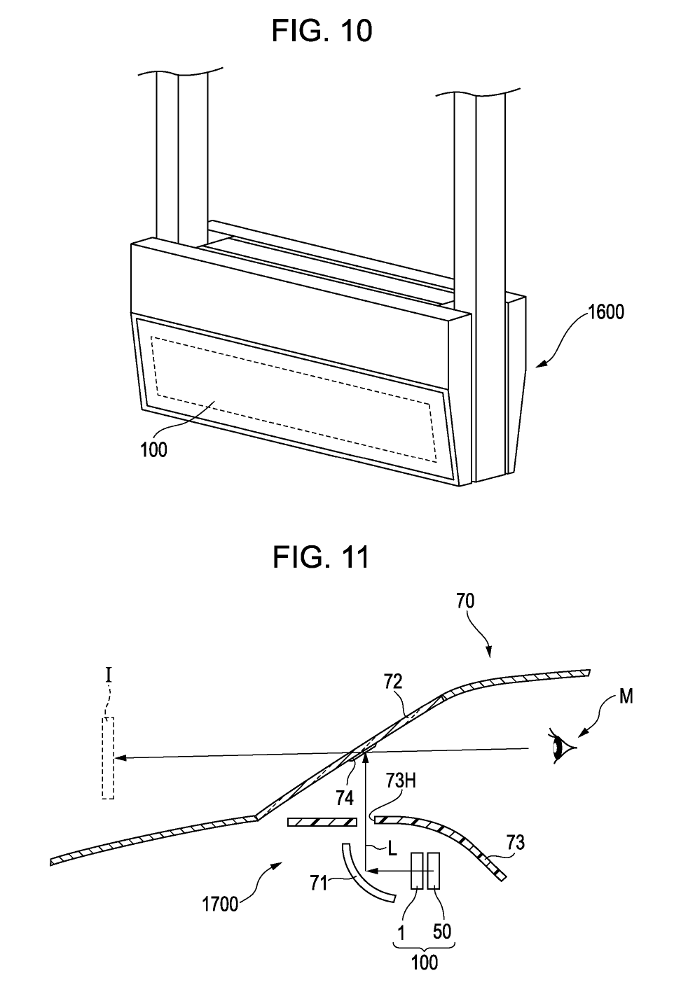

FIG. 10 is a schematic diagram illustrating an information display apparatus 1600 according to a first embodiment of an electronic apparatus of an electro-optic device 100. The information display apparatus 1600 is an information display apparatus which is installed on a ceiling or a wall at a station or many public facilities to display various types of guide information.

The information display apparatus 1600 includes the above-described electro-optic device 100 for displaying guide information. The electro-optic device 100 has the above-described configuration. Accordingly, when a viewer turns one's eyes from the guide information, the color breakup phenomenon does not occur, thereby realizing a bright and clear display.

### Second Embodiment of Electronic Apparatus

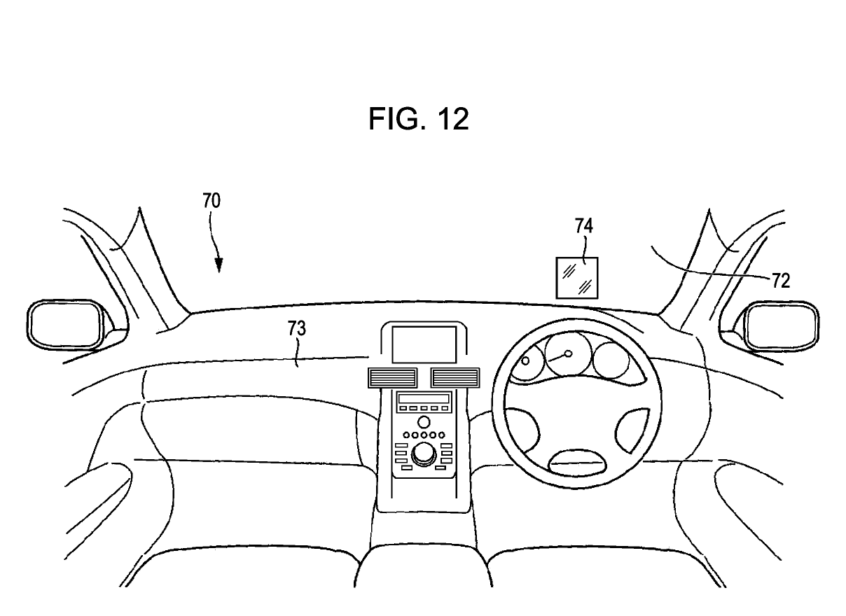

FIG. 11 is a schematic diagram illustrating a head-up display 1700 according to a second embodiment of the electronic apparatus. FIG. 12 shows that an image of the head-up display 1700 is viewed from a driver seat of a vehicle.

A vehicle 70 in FIG. 11 is a sedan type passenger car. A head-up display 1700 includes the electro-optic device 100, a concave mirror (reflective optics) 71 which projects light L (image light) radiated from the electro-optic device 100 toward a front window 72, and a front window shield 74 which reflects the light projected on the front window 72 toward the driver seat.

The electro-optic device 100 is installed inside a dashboard 73. On the dashboard 73, an opening 73H through which the light L passes is formed below the front window 72. The light L reflected through the opening 73H by the concave mirror 71 is projected on the front window shield 74. A projected image is a virtual image I and a passenger M of the vehicle views the image.

The front window shield 74 constitutes a sheet-shaped film such as a half-mirror, but a part of the light L may be reflected by performing a surface treatment on the front window 72. As shown in FIG. 12, the front window shield 74 is disposed in front of the driver seat. Information on a speed, an amount of gasoline, a warning, and the like is displayed on the front window shield 74. The passenger M can view the information without movement of the eyes while the passenger M drives the vehicle.

The electro-optic device 100 has the above-described configuration. Accordingly, when the passenger M turns the eyes from the front window shield 74 to surroundings while the passenger M drives the vehicle, the color breakup phenomenon does not occur and it is possible to avoid unnecessary stress of the passenger M. Even when it is necessary to swiftly turn the eyes from the front window shield 74 to the surrounding during the drive, the information is clearly displayed, thereby providing a comfortable driving environment. Since the electro-optic device 100 is installed in the narrow dashboard 73, a high-definition display device which can generate small heat is preferable. However, since the electro-optic device 100 according to this embodiment realizes high-definition and high luminance use efficiency using a field-sequential mode, the electro-optic device has an optimum configuration in the head-up display.

What is claimed is:

1. An electro-optic device of a field sequential mode comprising:
an electro-optic panel including a plurality of pixels and forming an image by controlling ON and OFF of the plurality of pixels; and
a light source unit radiating a first color light and a second color light to the pixels of the electro-optic panel,
wherein one frame time for forming one screen image in the electro-optic panel is divided into a plurality of fields including a first field and a second field, the light source unit radiating the first color light during the first field and radiating the second color light during the second field,
wherein in the electro-optic panel, a first image which is related to the first color light is formed in the first field, and a second image which is related to the second color light is formed in the second field, and
wherein the plurality of pixels of the electro-optic panel is not turned ON during two or more fields of one arbitrary frame time.

2. The electro-optic device according to claim 1, wherein the light source unit includes a plurality of color light sources that emit colors that are different from one another, and forms one color light by one of the plurality of color light sources or by combination of two or more of the color light sources.

3. The electro-optic device according to claim 2, wherein the light source unit forms one color light by combination of light emitted by two or more of the plurality of color light sources, and adjusts a color of the color light by adjusting an intensity ratio of the light emitted by the two or more of the plurality of color light sources.

4. The electro-optic device according to claim 1, wherein the light source unit constitutes a surface-shaped light source by two-dimensionally arranging a plurality of color light sources having different colors one another.

5. The electro-optic device according to claim 1,
wherein the light source unit includes a light source section, which has a plurality of color light sources that emit colors that are different from one another mounted on one chip, and a light guide plate which is arranged opposite the electro-optic panel so that the first color light and the second color light emitted by the light source section is radiated toward the electro-optic panel.

6. The electro-optic device according to claim 1, wherein the electro-optic panel is a liquid crystal panel which operates in an OCB mode or a liquid crystal panel which uses ferroelectric liquid crystal.

7. The electro-optic device according to claim 6, wherein the liquid crystal panel which operates in the OCB mode is driven at voltage equal to or less than voltage for transition between bend alignment and splay alignment.

8. The electro-optic device according to claim 6, wherein the light source unit radiates the color light after response of the pixels which are related to image formation becomes stable during every one field.

9. An electro-optic device of a field sequential mode comprising:
an electro-optic panel including a plurality of pixels and a plurality of image areas which includes a first image area and a second image area; and
a light source unit radiating a plurality of color light which is required to display the image, the plurality of color light including a first color light and a second color light to the pixels of the electro-optic panel,
wherein an image is formed by controlling ON and OFF of the plurality of pixels,
wherein one frame time for forming one screen image in the electro-optic panel is divided into a plurality of fields including a first field and a second field, the light source unit radiating the first color light during the first field and radiating the second color light during the second field,
wherein in the electro-optic panel, a first image which is related to the first color light is formed in the first field, and a second image which is related to the second color light is formed in the second field,
wherein the light source unit includes a plurality of color light sources that emit colors that are different from one another, and forms one of the plurality of color light by one of the plurality of color light sources or combination of two or more of the color light sources, and
wherein the first image which is related to the first color light is formed in the first image area, and the second image which is related to the second color light is formed in the second image area during one arbitrary frame time.

10. An electronic apparatus comprising the electro-optic device according to claim 1.
